(19) United States
(12) Patent Application Publication
(10) Pub. No.: US 2024/0290024 A1
(43) Pub. Date: Aug. 29, 2024

(54) DYNAMIC SYNTHETIC VIDEO CHAT AGENT REPLACEMENT

(71) Applicant: Loop Now Technologies, Inc., San Mateo, CA (US)

(72) Inventors: Wu-Hsi Li, Somerville, MA (US); Edwin Chiu, Cupertino, CA (US); Jerry Ting Kwan Luk, Menlo Park, CA (US); Hong-Ming Tseng, Toronto (CA); Jeremiah Kevin Tu, Sunnyvale, CA (US)

(73) Assignee: Loop Now Technologies, Inc., San Mateo, CA (US)

(21) Appl. No.: 18/585,188

(22) Filed: Feb. 23, 2024

Related U.S. Application Data
(60) Provisional application No. 63/613,312, filed on Dec. 21, 2023.
(60) Provisional application No. 63/604,261, filed on Nov. 30, 2023.
(60) Provisional application No. 63/546,768, filed on Nov. 1, 2023.
(60) Provisional application No. 63/546,077, filed on Oct. 27, 2023.
(60) Provisional application No. 63/536,245, filed on Sep. 1, 2023.
(60) Provisional application No. 63/524,900, filed on Jul. 4, 2023.
(60) Provisional application No. 63/522,205, filed on Jun. 21, 2023.
(60) Provisional application No. 63/472,552, filed on Jun. 12, 2023.
(60) Provisional application No. 63/464,207, filed on May 5, 2023.
(60) Provisional application No. 63/458,733, filed on Apr. 12, 2023.
(60) Provisional application No. 63/458,458, filed on Apr. 11, 2023.
(60) Provisional application No. 63/458,178, filed on Apr. 10, 2023.
(60) Provisional application No. 63/454,976, filed on Mar. 28, 2023.
(60) Provisional application No. 63/447,918, filed on Feb. 24, 2023.
(60) Provisional application No. 63/447,925, filed on Feb. 24, 2023.

(51) Int. Cl. G06T 13/40; G06T 19/20; G06V 40/10; G10L 13/033

(52) U.S. Cl. CPC G06T 13/40; G06T 19/20; G06V 40/10; G10L 13/0335; G06T 2219/2012; G06T 2219/2024

(57) ABSTRACT

Disclosed embodiments provide techniques for dynamic synthetic video chat agent replacement. A human host receives a request for a video chat initiated by a user. An image for a synthetic host including a representation of an individual is retrieved. The image of the synthetic host is selected based on information about the user. Aspects of the individual included in the image are extracted using one or more processors. A video performance by the human host responding to the statement or query by the user is captured. A synthetic host performance is created in which the video performance of the human host is dynamically replaced by the individual that was extracted so that the synthetic host performance responds to the user statement or query. The synthetic host performance is rendered to the user and supplemented with additional synthetic host performances as the video chat continues.

### RELATED APPLICATIONS

This application claims the benefit of U.S. provisional patent applications “Dynamic Synthetic Video Chat Agent Replacement” Ser. No. 63/447,918, filed Feb. 24, 2023, “Synthesized Realistic Metahuman Short-Form Video” Ser. No. 63/447,925, filed Feb. 24, 2023, “Synthesized Responses To Predictive Livestream Questions” Ser. No. 63/454,976, filed Mar. 28, 2023, “Scaling Ecommerce With Short-Form Video” Ser. No. 63/458,178, filed Apr. 10, 2023, “Iterative AI Prompt Optimization For Video Generation” Ser. No. 63/458,458, filed Apr. 11, 2023, “Dynamic Short-Form Video Transversal With Machine Learning In An Ecommerce Environment” Ser. No. 63/458,733, filed Apr. 12, 2023, “Immediate Livestreams In A Short-Form Video Ecommerce Environment” Ser. No. 63/464,207, filed May 5, 2023, “Video Chat Initiation Based On Machine Learning” Ser. No. 63/472,552, filed Jun. 12, 2023, “Expandable Video Loop With Replacement Audio” Ser. No. 63/522,205, filed Jun. 21, 2023, “Text-Driven Video Editing With Machine Learning” Ser. No. 63/524,900, filed Jul. 4, 2023, “Livestream With Large Language Model Assist” Ser. No. 63/536,245, filed Sep. 1, 2023, “Non-Invasive Collaborative Browsing” Ser. No. 63/546,077, filed Oct. 27, 2023, “AI-Driven Suggestions For Interactions With A User” Ser. No. 63/546,768, filed Nov. 1, 2023, “Customized Video Playlist With Machine Learning” Ser. No. 63/604,261, filed Nov. 30, 2023, and “Artificial Intelligence Virtual Assistant Using Large Language Model Processing” Ser. No. 63/613,312, filed Dec. 21, 2023.

Each of the foregoing applications is hereby incorporated by reference in its entirety.

### FIELD OF ART

This application relates generally to video analysis and more particularly to dynamic synthetic video chat replacement.

### BACKGROUND

Since the early days of film, current affairs have been portrayed to the public through video media. Cinema news programs began as early as 1908 when royal visits, official openings, sports events, and exceptional historical moments were captured, edited, and assembled for the viewing public. World War I accelerated this process as interest in the conflicts across Europe came to the attention of people around the globe. The advent of television and the development of television networks slowly brought news broadcasting to the attention of viewers in the United States. Many of the first news anchors had worked on radio or had done voice-over narration work for cinema newsreels. John Cameron Swayze became the anchor of the Came News Caravan in 1948. At the same time, he also anchored a quiz show called, “Who Said That”, in which celebrities tried to determine the speaker of quotations taken from recent news reports. Although Swayze was not a seasoned journalist, he created an on-air personality that people liked and responded to. He made eye contact and understood the role that hosts play in presenting information to viewers. Throughout his time hosting the news for NBC in the 1950s, people viewed Swayze's broadcasts more than any other.

As video news broadcasting grew, so did entertainment programming. Game shows, talk shows, variety shows, and even exercise shows all developed formats that included one or more on-camera hosts. Although there have been many successful hosts in each of these program types, certain attributes have been essential to many of them. First, clear communication is critical; hosts must be careful to pronounce names and products properly and must enunciate well. Second, energy and good humor help hosts to communicate enthusiasm, encouraging viewers to listen and join in. Third, confidence gives a host authority to talk about a product or event they represent. These attributes can be seen in many different hosts across the video landscape, with many different personality types. Successful hosts tend to listen well, communicate approachability, and research their topics thoroughly. They dress well for the audience they pursue and work to balance conversations during interviews rather than monopolizing the discussion. They practice their craft, just as many other successful people do, whatever their endeavor.

The growth of the Internet has brought a proliferation of video hosts across the spectrum of program formats. With the growth of short-form videos, brevity, along with clarity, have become increasingly important. Online viewers have short attention spans, so being concise is a valuable skill. As in other video media, confident speaking can command the attention of the audience and maintain interest. Knowing the content and the important points of any video being played as the host is speaking is imperative. This can be especially true in live video work, as the host interacts with guests and viewers. Less easy to define and yet another very important quality is for the host to be interesting. Stunning beauty or a massive facial scar are not necessary to be interesting. The key to being interesting is to be engaged with the audience, the guests, and the content of any video being portrayed as the host speaks. Speaking with energy, enthusiasm, and appropriate facial expressions can go a long way to ensure successful video hosting, regardless of the video format.

### SUMMARY

Video chats have become a routine method of communicating on many different types of internet platforms. Education, sales, technical support, help desks, etc., commonly employ video chats along with text chats, and audio options to enable users, customers, and students to interact with teachers, technical experts, and one another. Finding excellent video chat hosts can be a critical component to the success of a video chat, regardless of the type of communication being performed. Ecommerce consumers can discover and be influenced to purchase products or services based on recommendations from friends, peers, and informed sources, including effective video hosts. Users routinely divulge personal information in order to set up accounts granting access to video chats, and this information can be used to select chat hosts who can most effectively communicate with a user during a video chat session. Human hosts behind the scenes can respond to video chat users in real time, engaging the users and encouraging interest and sales opportunities. By harnessing the power of machine learning and artificial intelligence (AI), synthetic video chat hosts can be used to inform and promote products using images and voices best suited to the video chat users. Using the techniques of disclosed embodiments, it is possible to create effective and engaging video chat hosts in real time for education, support, and sales interactions.

Disclosed embodiments provide techniques for dynamic synthetic video chat agent replacement. A human host receives a request for a video chat initiated by a user. An image for a synthetic host including a representation of an individual is retrieved. The image of the synthetic host is selected based on information about the user. Aspects of the individual included in the image are extracted using one or more processors. A video performance by the human host responding to the statement or query by the user is captured. A synthetic host performance is created in which the video performance of the human host is dynamically replaced by the individual that was extracted so that the synthetic host performance responds to the user statement or query. The synthetic host performance is rendered to the user and supplemented with additional synthetic host performances as the video chat continues.

A computer-implemented method for video analysis is disclosed comprising: receiving, by a human host, a request for a video chat, wherein the request is initiated by a user; retrieving an image for a synthetic host, wherein the image includes a representation of an individual; extracting, using one or more processors, aspects of the individual from the image that was retrieved; capturing a video performance by the human host that is in response to a statement or query by the user; creating a synthetic host performance, wherein the video performance of the human host is replaced by the individual that was extracted, and wherein the synthetic host performance is created dynamically, and wherein the synthetic host performance responds to the statement or query by the user; rendering the video chat, wherein the video chat includes the synthetic host performance; and supplementing the video chat with one or more additional synthetic host performances. Some embodiments include customizing an appearance of the synthetic host, wherein the customizing is based on the information from the user. Some embodiments include highlighting, by the synthetic host, a product for sale. And some embodiments include creating an image of a synthetic host, wherein the creating is based on the individual from the image.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for dynamic synthetic video chat agent replacement.

FIG. 2 is a flow diagram for enabling a synthetic host.

FIG. 3 is an infographic dynamic synthetic video chat agent replacement.

FIG. 4 is an infographic for changing attributes of a synthetic host.

FIG. 5 is an infographic for retrieving an image based on user information.

FIG. 6 is an example dynamic synthetic video chat agent replacement.

FIG. 7 illustrates an ecommerce purchase.

FIG. 8 is a system diagram for dynamic synthetic video chat agent replacement.

### DETAILED DESCRIPTION

Locating, training, and deploying effective video chat hosts can be an expensive process, regardless of the type of chat host required. Preparing chat facilities; engaging staff; developing scripts and response flowcharts; and producing supplementary video, images, audio, and text can require many hours of work and a great deal of trial and error before effective chat hosts and content are ready. Ecommerce outlets, social media sites, and the ability for vendors, marketers, influencers, and shoppers to comment directly on products and services in real time are demanding shorter and shorter creation times for effective support pipelines and staff. Delays in promoting a product or service can result in lost sales opportunities, a reduction in market share, and lost revenue. Poor or ineffective communication by support or sales staff can hamper or even derail sales opportunities altogether, while strong, effective communication during a video chat can increase user engagement, sales opportunities, and revenue growth.

Disclosed embodiments address the demand for effective video chat hosts by leveraging a vast library of existing media assets and the expanding effectiveness of AI machine learning models. Media assets can include short-form videos, still images, audio clips, text, synthesized video, synthesized audio and more. Media assets are selected in real time based on user information included in video chat communications, and are presented to viewers in a dynamic and seamless manner. Comments and questions posed by users can be answered during the video chat, increasing engagement and the likelihood of sales. Production costs are reduced at the same time, as existing media assets are leveraged. Thus, disclosed embodiments improve the technical field of video analysis and generation.

Techniques for video analysis are disclosed. A user can initiate a video chat session from a website, during a livestream event, etc., and ask a question or make a comment. Information about the user, including demographic, economic, and geographic data can be combined with the image of the user captured from the video chat and can be used as input to an AI machine learning model. The AI neural network can analyze the user information to select an image of a synthetic host that can be customized to interact with the user during the video chat session. The customized synthetic host image can include a highlighted product for sale when required. A human host can view the user question or comment received in the video chat and respond. The human host response can be captured and used as input to an AI machine learning model. The AI model can be used to combine the selected image of the synthetic host with the performance of the human host to create a synthetic host performance so that the image and voice of the synthetic host replaces the human host. The synthetic host performance can be customized so that the background includes information about products for sale, product use, additional education options, etc. The synthetic host performance can be rendered to the video chat so that the user sees and hears the synthetic host responding to the comment or question submitted by the user. A split screen video chat window can be rendered so that the user sees him-or herself along with the synthetic host. If a text chat is being used, the user can see an image of the synthetic host along with the text responses from the human host. The user can continue to ask questions, make comments, and interact within the video chat as the AI model creates synthetic host responses by combining the human host responses with the selected synthetic host image. An ecommerce environment can be rendered along with the video chat so that the user can complete purchases of products for sale as the video chat plays.

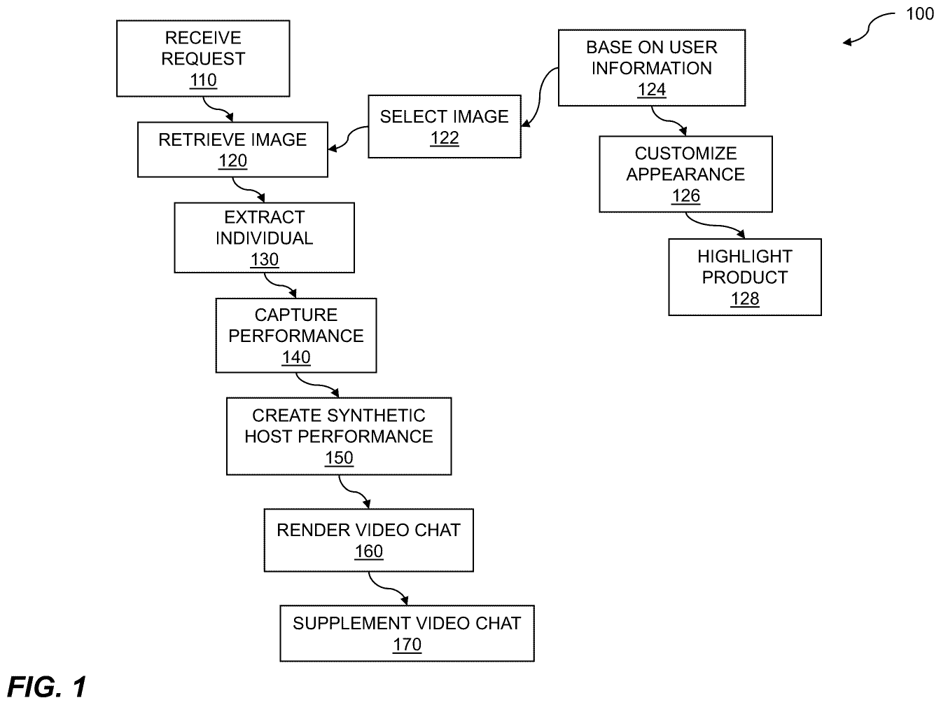

FIG. 1 is a flow diagram 100 for dynamic synthetic video chat agent replacement. The flow 100 includes receiving, by a human host, a request for a video chat 110, wherein the request is initiated by a user. In embodiments, the user statement or query can be comprised of text, voice audio, or video. The chat can be part of a website or social media host site, and can be used for sales, support, or education, etc. The request for a video chat 110 can include information about the user, such as demographic, economic, and geographic data. The user information can be collected as part of the user sign-on process allowing access to the website providing the chat service or can be supplied by a third-party site associated with the same username, such as an email address. In some embodiments, the user information can include an image of the user. The image of the user can be associated with the chat username or website hosting the chat. The image of the user can also be captured from the video chat.

The flow 100 includes retrieving an image for a synthetic host 120, wherein the image includes a representation of an individual. In some embodiments, the retrieving of image can include a video of the individual. The retrieving can further comprise selecting an image 122 of the individual based on the information about the user 124. An image of the user can be combined with the demographic, economic, and geographic information collected from the website hosting the chat and used as input to an artificial intelligence (AI) machine learning model. In embodiments, an AI machine learning model can be trained to recognize ethnicity, sex, and age. The AI machine learning model can access a library of images of individuals that can be used as synthetic hosts. The library of images can include options of ethnicity, sex, age, hair color and style, clothing, accessories, etc. Information related to each host image can be stored as metadata with each image. The flow 100 includes extracting, using one or more processors, aspects of the individual 130 from the image that was retrieved. In embodiments, the aspects of the individual can include clothing, accessories, facial expressions, gestures, and so on. The aspects of the individual can be isolated and altered, swapped, or deleted as needed in order to customize the appearance 126 of the image to be used as a synthetic host. The customizations can be used to create the best match of the synthetic host to the user that submitted the chat request. In some embodiments, a product for sale that is highlighted 128 as part of the website hosting the chat or highlighted by the host during the chat can be included in the customizing of the appearance of the synthetic host.

The flow 100 includes capturing a video performance 140 by the human host that is in response to a statement or query by the user. The chat with the user can be comprised of text, voice audio, or video. The human host can interact with the user in real time and can provide additional information regarding products for sale, support options, research materials, websites with further information, etc. The video performance by the human host can be used as input to an AI machine learning model. The AI model can separate the human host from the background and can isolate various elements of the human host performance, including facial features, gestures, articles of clothing, accessories, vocal inflections, tone, cadence, the text of the words spoken by the host, etc.

The flow 100 includes creating a synthetic host performance 150, wherein the video performance of the human host is replaced by the individual that was extracted, and wherein the synthetic host performance is created dynamically, and wherein the synthetic host performance responds to the statement or query by the user. In embodiments, the creating of an image of a synthetic host is based on the individual from the selected image. Synthesized host videos are created using a generative model. Generative models are a class of statistical models that can generate new data instances. The generative model can include a generative adversarial network (GAN). A generative adversarial network (GAN) includes two parts. A generator learns to generate plausible data. The generated instances are input to a discriminator. The discriminator learns to distinguish the generator's fake data from real data. The discriminator penalizes the generator for generating implausible results. During the training process, over time, the output of the generator improves, and the discriminator has less success distinguishing real output from fake output. The generator and discriminator can be implemented as neural networks, with the output of the generator connected to the input of the discriminator. Embodiments may utilize backpropagation to create a signal that the generator neural network uses to update its weights.

The discriminator may use training data coming from two sources, real data, which can include images of real objects (the human host of the chat, products for sale, etc.), and fake data, which are images created by the generator based on the image selected to be used as the synthetic host. The discriminator uses the fake data as negative examples during the training process. A discriminator loss function is used to update weights via backpropagation for discriminator loss when it misclassifies an image. The generator learns to create fake data by incorporating feedback from the discriminator. Essentially, the generator learns how to “trick” the discriminator into classifying its output as real. A generator loss function is used to penalize the generator for failing to trick the discriminator. Thus, in embodiments, the generative adversarial network (GAN) includes two separately trained networks. The discriminator neural network can be trained first, followed by training the generative neural network, until a desired level of convergence is achieved. In embodiments, multiple images of a synthetic host may be used to create a synthesized chat video that replaces the human host performance in the chat with a performance by the synthesized host. The creating of the synthetic host performance can include changing attributes of the synthetic host to customize the appearance of the synthetic host 126. The attributes can include gestures, articles of clothing, facial expressions accessories, and a background image. In some embodiments, creating a synthetic host performance can include changing a background of the synthetic host. Changing the background can include images, text, audio, or video added to the performance in order to highlight products for sale 128, underscore important concepts, demonstrate product uses, etc.

The flow 100 includes rendering the video chat 160, wherein the video chat includes the synthetic host performance. In embodiments, the video chat includes the user and the synthetic host, displayed in a split screen display. The user can see and hear the synthetic host performing the response, captured from the human host, to the user's comment or question. In some embodiments, an image of the synthetic host is displayed to the user. Text chats can include an image or avatar of the chat participant. The user can see an image of the user associated with his or her text messages and an image of the synthetic host associated with the text responses from the human host.

In some embodiments, the video chat can support an ecommerce purchase. A device used to participate in a video chat can be an Over-the-Top (OTT) device such as a mobile phone, laptop computer, tablet, pad, or desktop computer, etc. The accessing of the video chat can be accomplished using a browser or another application running on the device. A product card can be generated and rendered on the device viewing the video chat. In embodiments, the product card represents at least one product available for purchase on the website hosting the chat or highlighted during the video chat. Embodiments can include inserting a representation of a product for sale into the on-screen product card. A product card is a graphical element such as an icon, thumbnail picture, thumbnail video, symbol, or other suitable element that is displayed in front of the video. The product card is selectable via a user interface action such as a press, swipe, gesture, mouse click, verbal utterance, or other suitable user action. When the product card is invoked, an in-frame shopping environment can be rendered over a portion of the video chat while the chat continues to play. This rendering enables an ecommerce purchase by a user while preserving a continuous video chat session. In other words, the user is not redirected to another site or portal that causes the video chat to stop. Thus, viewers are able to initiate and complete a purchase completely inside of the video chat user interface, without being directed away from the currently playing chat. Allowing the video chat to play during the purchase can enable improved audience engagement, which can lead to additional sales and revenue, one of the key benefits of disclosed embodiments. In some embodiments, the additional on-screen display that is rendered upon selection or invocation of a product card conforms to an Interactive Advertising Bureau (IAB) format. A variety of sizes are included in IAB formats, such as for a smartphone banner, mobile phone interstitial, and the like.

The flow 100 includes supplementing the video chat 170 with one or more additional synthetic host performances, based on at least one further statement or query by the user. In embodiments, the user can continue to make comments, ask questions, and participate in the video chat after the first synthetic host performance has been rendered. The human host can see the chat comments made by the user and respond to them. As the human host responds, an AI machine learning model can generate additional synthetic host performances 150, using the image selected and customized after the initial chat request was received. In this way, the user continues to be engaged by the synthetic host and is encouraged to participate in additional sales opportunities, continuing education classes, etc.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

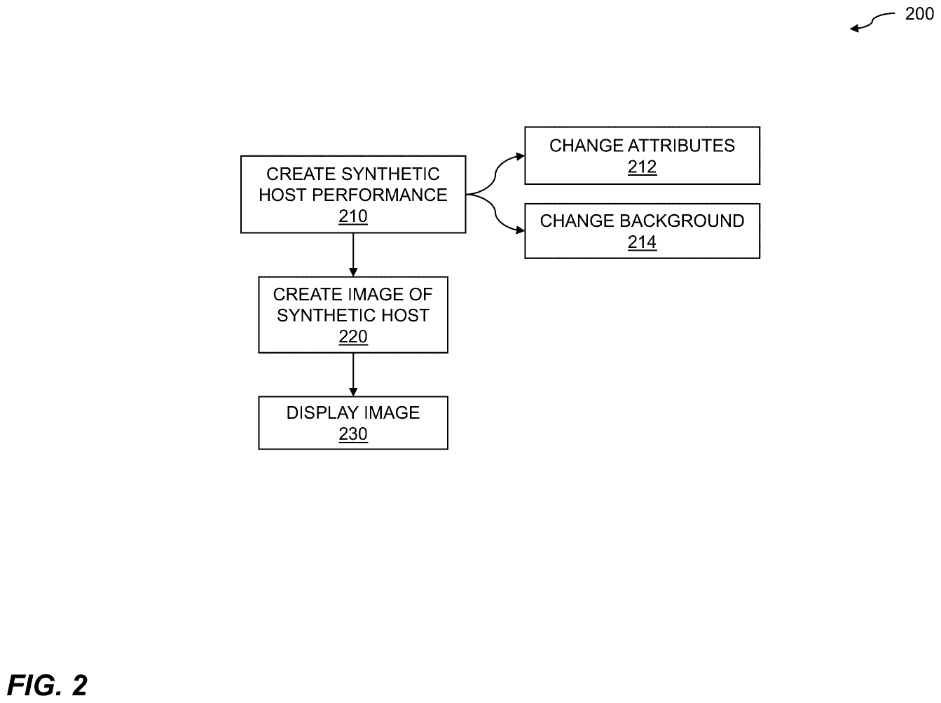

FIG. 2 is a flow diagram 200 for enabling a synthetic host. A user can initiate a video chat session from a vendor website, as part of a livestream event, and so on, to ask a question or make a comment. Information about the user, including demographic, economic, and geographic data collected by the host website, can be combined with the image of the user captured from the video chat and used as input to an AI machine learning model. The AI neural network can analyze the user information to select an image of a synthetic host that can be customized to interact with the user during the video chat session. A human host can view the user question or comment received in the video chat and can respond to it. The human host response can be captured and used as input to an AI machine learning model. The AI model can be used to combine the selected image of the synthetic host with the performance of the human host to create a synthetic host performance so that the image and voice of the synthetic host replaces the human host. The synthetic host performance can be customized so that the background includes information about products for sale, product use, additional education options, etc. The synthetic host performance can be rendered to the video chat so that the user sees and hears the synthetic host responding to the comment or question submitted by the user. If a text chat is being used, the user can see an image of the synthetic host along with the text responses from the human host.

The flow 200 includes creating a synthetic host performance 210. As described above and throughout, a request for a video chat can be generated by a user. In embodiments, information about the user can be included with the video chat request, including demographic, economic, and geographic data, and an image of the user. The image of the user can be associated with the chat username, the website hosting the chat, or can be captured from the video chat directly. Based on the user data, an image for a synthetic host, including a representation of an individual, can be selected. The image for a synthetic host can be selected by inputting the user data into an artificial intelligence (AI) machine learning model. In embodiments, an AI machine learning model can be trained to recognize ethnicity, sex, age, and other information about the user by analyzing the user image, demographic, economic, and geographic data. The AI machine learning model can access a library of images of individuals that can be used as synthetic hosts. The library of images can include options of ethnicity, sex, age, hair color and style, clothing, accessories, etc. Attributes of the individual from the selected image can be isolated and analyzed, including clothing, accessories, facial expressions, gestures, and so on. The attributes of the individual can be changed, swapped, or deleted as needed in order to customize the appearance of the image to be used as a synthetic host. The customizations can be used to create the best match of the synthetic host to the user that submitted the chat request.

In embodiments, a video chat response to the user statement or query can be performed by a human host. The human host can interact with the user in real time and provide additional information regarding products for sale, support options, research materials, websites with further information, etc. The video performance by the human host can be captured and used as input to an AI machine learning model. The AI model can separate the human host from the background and can isolate various elements of the human host performance, including facial features, gestures, articles of clothing, accessories, vocal inflections, tone, cadence, the text of the words spoken by the host, etc.

In embodiments, the synthetic host performance is created from the image of the individual selected by the AI machine learning model combined with the video chat response of a human host to the user. Synthesized host videos are created using a generative model. Generative models are a class of statistical models that can generate new data instances. The generative model can include a generative adversarial network (GAN). A generative adversarial network (GAN) includes two parts. A generator learns to generate plausible data. The generated instances are input to a discriminator. The discriminator learns to distinguish the generator's fake data from real data. The discriminator penalizes the generator for generating implausible results. During the training process, over time, the output of the generator improves, and the discriminator has less success distinguishing real output from fake output. The generator and discriminator can be implemented as neural networks, with the output of the generator connected to the input of the discriminator. Embodiments may utilize backpropagation to create a signal that the generative neural network uses to update its weights.

The discriminator may use training data coming from two sources, real data, which can include images of real objects (the human host of the chat, products for sale, etc.), and fake data, which are images created by the generator based on the image selected to be used as the synthetic host. The discriminator uses the fake data as negative examples during the training process. A discriminator loss function is used to update weights via backpropagation for discriminator loss when it misclassifies an image. The generator learns to create fake data by incorporating feedback from the discriminator. Essentially, the generator learns how to “trick” the discriminator into classifying its output as real. A generator loss function is used to penalize the generator for failing to trick the discriminator. Thus, in embodiments, the generative adversarial network (GAN) includes two separately trained networks. The discriminator neural network can be trained first, followed by training the generative neural network, until a desired level of convergence is achieved. In embodiments, multiple images of a synthetic host may be used to create a synthetic host performance that replaces the human host performance in the chat with a performance by the synthetic host. In the flow 200, the creating of the synthetic host performance can include changing attributes 212 of the synthetic host. The attributes can include gestures, articles of clothing and accessories, facial expressions, vocal tone, inflection, rhythm, and so on. The background of the human host performance can also be isolated and changed 214 to include images, videos of products for sale, text, etc. In the resulting video chat, the user can see and hear the synthetic host performing the response captured from the human host to the user's comment or question.

The flow 200 includes creating an image of synthetic host 220 to be displayed to the user. In embodiments, the image of the synthetic host can be created from the synthetic host performance video. In some embodiments, the chat statement or query submitted by the user can be a text or voice audio chat. Text chats can include an image or avatar of the chat participant. The image of the synthetic host created from the synthetic host performance video can be used as the image or avatar of the host in a text chat window. Thus, the user can see an image or avatar of the user associated with his or her text messages and an image of the synthetic host displayed 230 with the text responses from the human host. Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

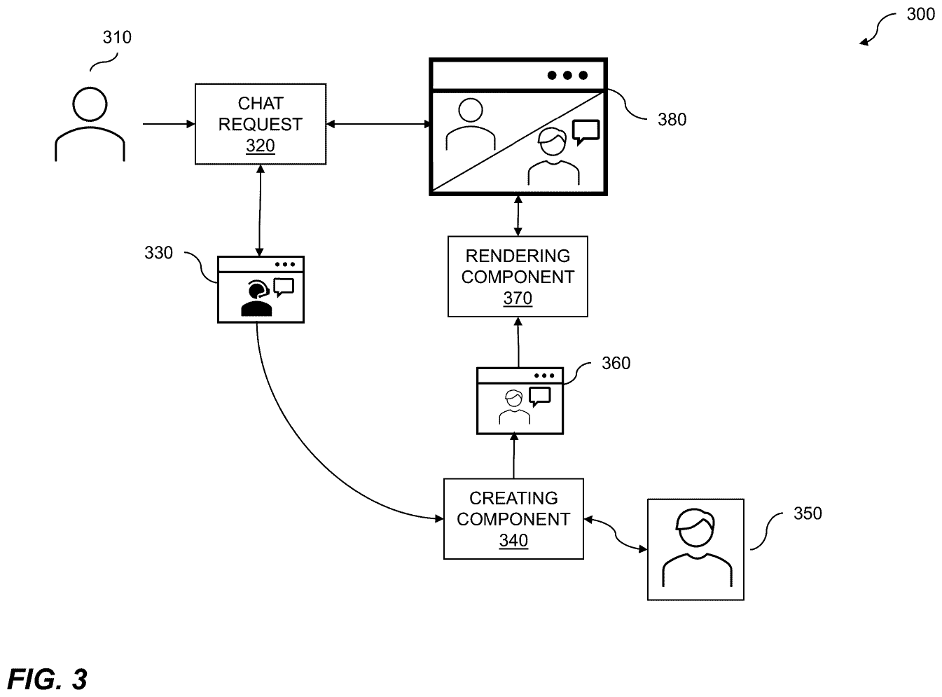

FIG. 3 is an infographic 300 for dynamic synthetic video chat agent replacement. The infographic 300 includes receiving, by a human host 330, a request for a video chat 320, wherein the request is initiated by a user 310. In embodiments, the chat request statement or query by the user can be a text, voice audio, or video chat request. The chat can be part of a website or social media host site and can be used for sales, support, education, etc. In some embodiments, the request for a video chat 320 can include information about the user 310, such as demographic, economic, and geographic data. The user information can be collected as part of the user sign-on process allowing access to the website providing the chat service, or can be supplied by a third-party site associated with the same username, such as an email address. The user information can include an image of the user. The image of the user 310 can be associated with the chat username or website hosting the chat, or can be captured from the video chat request.

The infographic 300 includes retrieving an image for a synthetic host 350, wherein the image includes a representation of an individual. In some embodiments, the retrieving of image can include a video of the individual. The retrieving can further comprise retrieving an image of the individual based on information about the user. An image of the user can be combined with the demographic, economic, and geographic information collected from the website hosting the chat and can be used as input to an artificial intelligence (AI) machine learning model. In embodiments, an AI machine learning model can be trained to recognize ethnicity, sex, and age. The AI machine learning model can access a library of images of individuals that can be used as synthetic hosts. The library of images can include options of ethnicity, sex, age, hair color and style, clothing, accessories, etc. Information related to each host image can be stored as metadata with each image.

The infographic 300 includes capturing a video performance by the human host 330 that is in response to a statement or query by the user 310. The human host 330 can interact with the user 310 in real time and can provide additional information regarding products for sale, support options, research materials, websites with further information, etc. The audio and video performance by the human host can be captured and used as input to an AI machine learning model. The AI model can separate the human host from the background and can isolate various elements of the human host performance, including facial features, gestures, articles of clothing, accessories, vocal inflections, tone, cadence, the text of the words spoken by the host, etc.

The infographic 300 includes extracting, using one or more processors, aspects of the individual from the image that was retrieved. In embodiments, the aspects of the individual can include clothing, accessories, facial expressions, gestures, and so on. The aspects of the individual can be isolated and altered, swapped, or deleted as needed in order to customize the appearance of the image to be used as a synthetic host. The customizations can be used to create the best match of the synthetic host to the user that submitted the chat request. In some embodiments, a product for sale that is highlighted as part of the website hosting the chat, or highlighted by the host during the chat, can be included in the customizing of the appearance of the synthetic host. The extracting is accomplished using machine learning. Machine learning artificial intelligence (AI) algorithms can be used to separate an individual in the foreground of an image from the remainder of the image, and to separate specific elements of the image from the individual. The extracted image or images of the individual can be used to generate a 3D model of the individual's head, face, and in some implementations, upper body.

The infographic 300 includes creating 340 a synthetic host performance 360, wherein the video performance of the human host is replaced by the individual that was extracted, and wherein the synthetic host performance 360 is created dynamically and wherein the synthetic host performance 360 responds to the statement or query by the user 310. In embodiments, creating a synthetic host performance can include changing a background of the synthetic host, wherein the background comprises images, text, audio, or video. Synthesized host videos are created using a generative model. Generative models are a class of statistical models that can generate new data instances. The generative model can include a generative adversarial network (GAN). A generative adversarial network (GAN) includes two parts. A generator learns to generate plausible data. The generated instances are input to a discriminator. The discriminator learns to distinguish the generator's fake data from real data. The discriminator penalizes the generator for generating implausible results. During the training process, over time, the output of the generator improves, and the discriminator has less success distinguishing real output from fake output. The generator and discriminator can be implemented as neural networks, with the output of the generator connected to the input of the discriminator. Embodiments may utilize backpropagation to create a signal that the generator neural network uses to update its weights.

The discriminator may use training data coming from two sources, real data, which can include images of real objects (the captured human host response, products for sale, etc.), and fake data, which are images created by the generator based on the image selected to be used as the synthetic host 350. The discriminator uses the fake data as negative examples during the training process. A discriminator loss function is used to update weights via backpropagation for discriminator loss when it misclassifies an image. The generator learns to create fake data by incorporating feedback from the discriminator. Essentially, the generator learns how to “trick” the discriminator into classifying its output as real. A generator loss function is used to penalize the generator for failing to trick the discriminator. Thus, in embodiments, the generative adversarial network (GAN) includes two separately trained networks. The discriminator neural network can be trained first, followed by training the generative neural network, until a desired level of convergence is achieved. In embodiments, multiple images of a synthetic host may be used to create a synthesized chat video that replaces the human host performance in the chat with a performance by the synthesized host. In some embodiments, creating a synthetic host performance can include changing the background of the synthetic host. Changing the background can include images, text, audio, or video added to the performance in order to highlight products for sale, underscore important concepts, demonstrate product uses, etc.

The infographic 300 includes rendering 370 the video chat 380, wherein the video chat 380 includes the synthetic host performance. In embodiments, the video chat includes the user and the synthetic host. The user and the synthetic host are displayed in a split screen display. The user can see and hear the synthetic host performing the response captured from the human host 330 to the user's comment or question. In some embodiments, an image of the synthetic host is displayed to the user. Text chats can include an image or avatar of the chat participant. The user can see an image of the user associated with his or her text messages and an image of the synthetic host 350 associated with the text responses from the human host.

The infographic 300 includes supplementing the video chat 380 with one or more additional synthetic host performances. The one or more additional host performances can be based on at least one further statement or query by the user. In embodiments, the user can continue to make comments, ask questions, and participate in the video chat after the first synthetic host performance has been rendered 370. The human host can see the chat comments made by the user and respond to them. As the human host responds, an AI machine learning model can generate additional synthetic host performances, using the image selected after the initial chat request was received. In this way, the user continues to be engaged by the synthetic host and is encouraged to participate in additional sales opportunities, continuing education classes, etc.

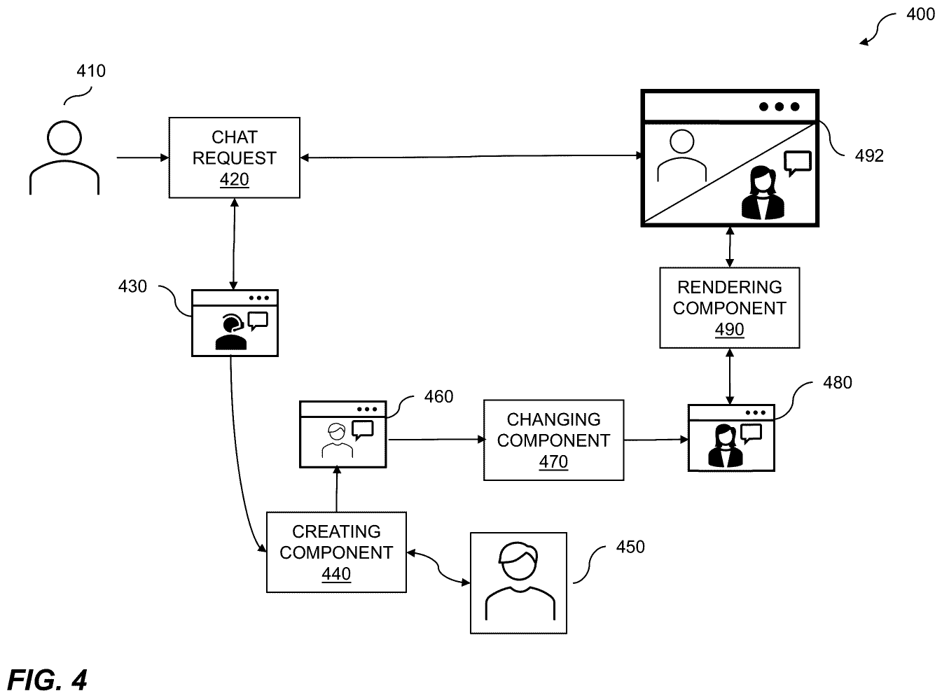

FIG. 4 is an infographic 400 for changing attributes of a synthetic host. The infographic 400 includes receiving, by a human host 430, a request for a video chat 420, wherein the request is initiated by a user 410. In embodiments, the chat request statement or query by the user can be a text chat, voice audio, or video chat request. The chat can be part of a website or social media host site and can be used for sales, support, education, etc. The human host 430 can read the text, hear the audio, or view the video chat request 420 as it is captured and relayed to an AI machine learning model. Audio chat requests can be converted to text to allow for further analysis by an AI machine learning model and to be seen and read by the human host. In some embodiments, the request for a video chat 420 can include information about the user 410, such as demographic, economic, and geographic data. The user information can include an image of the user collected from the website hosting the chat, or a social media platform, or it can be captured from the video chat request. The image of the user 410 can be associated with a text chat username. The user information can be collected as part of the user sign-on process allowing access to the website providing the chat service, or can be supplied by a third-party site associated with the same username, such as an email address.

The infographic 400 includes capturing a video performance by the human host 430 that is in response to a statement or query by the user. The human host can interact with the user in real time and can provide additional information regarding products for sale, support options, research materials, websites with further information, etc. The audio and video performance by the human host can be captured and used as input to an AI machine learning model. The AI model can separate the human host from the background and can isolate various elements of the human host performance, including facial features, gestures, articles of clothing, accessories, vocal inflections, tone, cadence, the text of the words spoken by the host, etc.

The infographic 400 includes retrieving an image 450 for a synthetic host, wherein the image includes a representation of an individual. In some embodiments, the retrieving of image can include a video of the individual. The retrieving can further comprise retrieving an image of the individual based on information about the user. An image of the user can be combined with the demographic, economic, and geographic information collected from the website hosting the chat and can be used as input to an artificial intelligence (AI) machine learning model. In embodiments, an AI machine learning model can be trained to recognize ethnicity, sex, and age. The AI machine learning model can access a library of images of individuals that can be used as synthetic hosts. The library of images can include options of ethnicity, sex, age, hair color and style, clothing, accessories, etc. Information related to each host image can be stored as metadata with each image.

The infographic 400 includes extracting, using one or more processors, aspects of the individual from the image that was retrieved. In embodiments, the aspects of the individual can include clothing, accessories, facial expressions, gestures, and so on. The aspects of the individual can be isolated and altered, swapped, or deleted as needed in order to change the appearance of the image to be used as a synthetic host. The changes can be used to create the best match of the synthetic host to the user that submitted the chat request. In some embodiments, a product for sale that is highlighted as part of the website hosting the chat or highlighted by the host during the chat can be included in the changing of the appearance of the synthetic host. The extracting of aspects of the individual is accomplished using machine learning. Machine learning artificial intelligence (AI) algorithms can be used to separate an individual in the foreground of an image 450 from the remainder of the image, and to separate specific elements of the image from the individual. The extracted image or images of the individual can be used to generate a 3D model of the individual's head, face, and in some implementations, upper body.

The infographic 400 includes creating 440 a synthetic host performance 460, wherein the video performance of the human host 430 is replaced by the individual that was extracted, and wherein the synthetic host performance 460 is created dynamically and wherein the synthetic host performance 460 responds to the statement or query by the user. In embodiments, creating a synthetic host performance can include changing a background of the synthetic host, wherein the background comprises images, text, audio, or video. Synthesized host performances are created using a generative model. Generative models are a class of statistical models that can generate new data instances. The generative model can include a generative adversarial network (GAN). A generative adversarial network (GAN) includes two parts. A generator learns to generate plausible data. The generated instances are input to a discriminator. The discriminator learns to distinguish the generator's fake data from real data. The discriminator penalizes the generator for generating implausible results. During the training process, over time, the output of the generator improves, and the discriminator has less success distinguishing real output from fake output. The generator and discriminator can be implemented as neural networks, with the output of the generator connected to the input of the discriminator. Embodiments may utilize backpropagation to create a signal that the generative neural network uses to update its weights.

The discriminator may use training data coming from two sources, real data, which can include images of real objects (the captured human host response, products for sale, etc.), and fake data, which are images created by the generator 440 based on the image 450 selected to be used as the synthetic host. The discriminator uses the fake data as negative examples during the training process. A discriminator loss function is used to update weights via backpropagation for discriminator loss when it misclassifies an image. The generator learns to create fake data by incorporating feedback from the discriminator. Essentially, the generator learns how to “trick” the discriminator into classifying its output as real. A generator loss function is used to penalize the generator for failing to trick the discriminator. Thus, in embodiments, the generative adversarial network (GAN) includes two separately trained networks. The discriminator neural network can be trained first, followed by training the generative neural network, until a desired level of convergence is achieved. In embodiments, multiple images of a synthetic host may be used to create a synthesized chat video that replaces the human host performance in the chat with a performance by the synthesized host. In some embodiments, creating a synthetic host performance can include changing the background of the synthetic host. Changing the background can include images, text, audio, or video added to the performance in order to highlight products for sale, underscore important concepts, demonstrate product uses, etc.

The infographic 400 includes changing attributes 470 of the synthetic host. The attributes can include gestures, articles of clothing, facial expressions, accessories, and background images. The process of changing attributes of the synthetic host 470 is the same as described above and throughout to create 440 the synthetic host performance. In embodiments, the attribute changing is accomplished to fit the appearance and voice of the synthetic host to the preferences of the user in order to encourage engagement with the synthetic host. For instance, the AI machine learning model may determine that the best synthetic host match for user would be a female synthetic host with dark hair rather than a male synthetic host with light hair. Continued engagement with a synthetic host can lead to additional sales opportunities, continuing education classes, etc. In some embodiments, creating a synthetic host performance can include changing a background of the synthetic host. Changing the background can include images, text, audio, or video added to the performance in order to highlight products for sale, underscore important concepts, demonstrate product uses, and so on.

The infographic 400 includes rendering 490 the video chat 480, wherein the video chat 480 includes the synthetic host performance. In embodiments, the video chat 480 includes the user 410 and the synthetic host. The user and the synthetic host are displayed in a split screen display 492. The user can see and hear the synthetic host performing the response captured from the human host to the user's comment or question. In some embodiments, an image of the synthetic host is displayed to the user. Text chats can include an image or avatar of the chat participant. The user can see their own image associated with his or her text messages and an image of the synthetic host associated with the text responses from the human host.

The infographic 400 includes supplementing the video chat 480 with one or more additional synthetic host performances. The one or more additional host performances can be based on at least one further statement or query by the user. In embodiments, the user can continue to make comments, ask questions, and participate in the video chat after the first synthetic host performance has been rendered 490. The human host can see the chat comments made by the user and respond to them. As the human host responds, an AI machine learning model can generate additional synthetic host performances 480, using the image 450 and the attribute changes selected after the initial chat request 420 was received. In this way, the user 410 continues to be engaged by the synthetic host 480 and is encouraged to participate in additional sales opportunities, continuing education classes, etc.

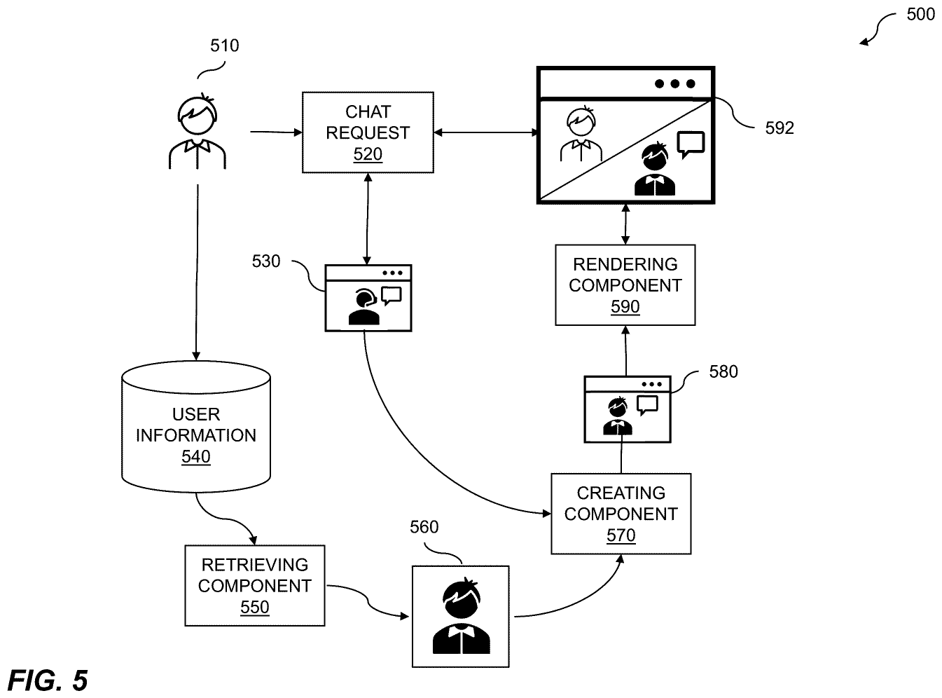

FIG. 5 is an infographic 500 for retrieving an image based on user information. The infographic 500 includes receiving, by a human host 530, a request for a video chat 520, wherein the request is initiated by a user 510. In embodiments, the chat request statement or query by the user can be a text chat, voice audio, or video chat request. The chat can be part of a website or social media host site and can be used for sales, support, education, etc. The human host can read the text, hear the audio, or view the video chat request as it is captured and relayed to an AI machine learning model. Audio chat requests can be converted to text to allow for further analysis by an AI machine learning model and to be seen and read by the human host.

The infographic 500 includes user information 540 such as demographic, economic, and geographic data. In embodiments, the user information can be included with the request for a video chat. The user information 540 can include an image of the user collected from the website hosting the chat, a social media platform, or it can be captured from the video chat request. In some instances, the image of the user can be associated with a text chat username. The user information 540 can be collected as part of the user sign-on process allowing access to the website providing the chat service or supplied by a third-party site associated with the same username, such as an email address.

The infographic 500 includes capturing a video performance by the human host 530 that is in response to a statement or query by the user. The human host 530 can interact with the user 510 in real time and can provide additional information regarding products for sale, support options, research materials, websites with further information, etc. The audio and video performance by the human host 530 can be captured and used as input to an AI machine learning creating component 570. The AI machine learning creating component 570 can separate the human host from the background and can isolate various elements of the human host performance, including facial features, gestures, articles of clothing, accessories, vocal inflections, tone, cadence, the text of the words spoken by the host, etc.

The infographic 500 includes a retrieving component 550 that can retrieve an image 560 for a synthetic host, wherein the image includes a representation of an individual. In some embodiments, the retrieving of an image can include a video of the individual. The retrieving component can further comprise retrieving an image of the individual based on information about the user. An image of the user 510 can be combined with the demographic, economic, and geographic information collected from the website hosting the chat and can be used as input to an artificial intelligence (AI) machine learning model. In embodiments, an AI machine learning creating component can be trained to recognize ethnicity, sex, and age. The AI machine learning creating component can access a library of images of individuals that can be used as synthetic hosts. The library of images can include options of ethnicity, sex, age, hair color and style, clothing, accessories, etc. Information related to each host image can be stored as metadata with each image.

The infographic 500 includes extracting, using one or more processors, aspects of the individual from the image that was retrieved. In embodiments, the aspects of the individual can include clothing, accessories, facial expressions, gestures, and so on. The aspects of the individual can be isolated and altered, swapped, or deleted as needed in order to change the appearance of the image to be used as a synthetic host. The changes can be used to create the best match of the synthetic host to the user that submitted the chat request. In some embodiments, a product for sale that is highlighted as part of the website hosting the chat, or highlighted by the host during the chat, can be included in the changing of the appearance of the synthetic host. The extracting of aspects of the individual is accomplished using machine learning. Machine learning artificial intelligence (AI) algorithms can be used to separate an individual in the foreground of an image from the remainder of the image, and to separate specific elements of the image from the individual. The extracted image or images of the individual can be used to generate a 3D model of the individual's head, face, and in some implementations, upper body.

The infographic 500 includes creating a synthetic host performance 580, wherein the video performance of the human host is replaced by the individual that was extracted, and wherein the synthetic host performance is created dynamically and wherein the synthetic host performance responds to the statement or query by the user. In embodiments, creating a synthetic host performance can include changing a background of the synthetic host, wherein the background comprises images, text, audio, or video. Synthesized host performances are created using a generative model. Generative models are a class of statistical models that can generate new data instances. The generative model can include a generative adversarial network (GAN). A generative adversarial network (GAN) includes two parts. A generator learns to generate plausible data. The generated instances are input to a discriminator. The discriminator learns to distinguish the generator's fake data from real data. The discriminator penalizes the generator for generating implausible results. During the training process, over time, the output of the generator improves, and the discriminator has less success distinguishing real output from fake output. The generator and discriminator can be implemented as neural networks, with the output of the generator connected to the input of the discriminator. Embodiments may utilize backpropagation to create a signal that the generator neural network uses to update its weights.

The discriminator may use training data coming from two sources, real data, which can include images of real objects (the captured human host response, products for sale, etc.), and fake data, which are images created by the generator 570 based on the image selected 560 to be used as the synthetic host. The discriminator uses the fake data as negative examples during the training process. A discriminator loss function is used to update weights via backpropagation for discriminator loss when it misclassifies an image. The generator learns to create fake data by incorporating feedback from the discriminator. Essentially, the generator learns how to “trick” the discriminator into classifying its output as real. A generator loss function is used to penalize the generator for failing to trick the discriminator. Thus, in embodiments, the generative adversarial network (GAN) includes two separately trained networks. The discriminator neural network can be trained first, followed by training the generative neural network, until a desired level of convergence is achieved. In embodiments, multiple images of a synthetic host may be used to create a synthesized chat video that replaces the human host performance in the chat with a performance by the synthesized host. In some embodiments, creating a synthetic host performance can include changing the background of the synthetic host. Changing the background can include images, text, audio, or video added to the performance in order to highlight products for sale, underscore important concepts, demonstrate product uses, etc.

The infographic 500 includes rendering 590 the video chat, wherein the video chat includes the synthetic host performance. In embodiments, the video chat includes the user and the synthetic host. The user and the synthetic host are displayed in a split screen display 592. The user can see and hear the synthetic host performing the response captured from the human host 530 to the user's comment or question. In some embodiments, an image of the synthetic host is displayed to the user. Text chats can include an image or avatar of the chat participant. The user can see their own image associated with his or her text messages and an image of the synthetic host associated with the text responses from the human host.

The infographic 500 includes supplementing the video chat with one or more additional synthetic host performances. The one or more additional host performances can be based on at least one further statement or query by the user. In embodiments, the user can continue to make comments, ask questions, and participate in the video chat after the first synthetic host performance has been rendered 590. The human host can see the chat comments made by the user and respond to them. As the human host responds, an AI machine learning model can generate additional synthetic host performances, using the image and the attribute changes selected after the initial chat request was received. In this way, the user continues to be engaged by the synthetic host and can be encouraged to participate in additional sales opportunities, continuing education classes, etc.

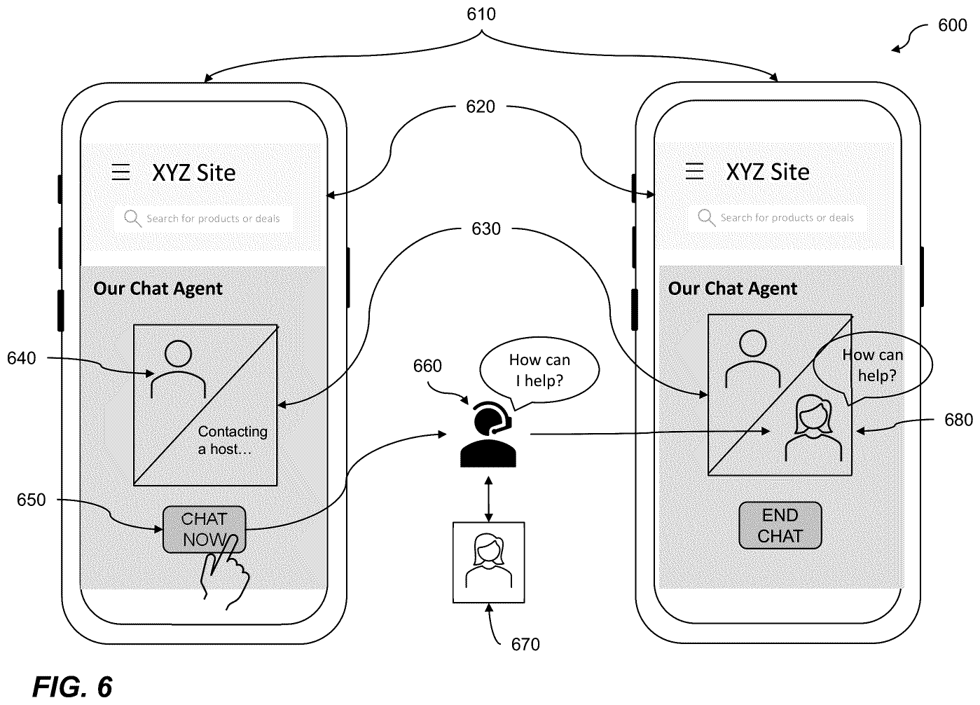

FIG. 6 is an example of dynamic synthetic video chat replacement. The example 600 includes a connected television (CTV) device 610 that can be used to participate in a video chat 630 hosted as part of a website, social media platform, or livestream event 620. A connected television (CTV) is any television set connected to the Internet, including smart TVs with built-in internet connectivity, or televisions connected to the Internet via set-top boxes, TV sticks, and gaming consoles. Connected TV can also include Over-the-Top (OTT) video devices or services accessed by a laptop, desktop, pad, or mobile phone. Content for television can be accessed directly from the Internet without using a cable or satellite set-top box.

The example 600 includes an image or video of the user 640 initiating the video chat 630. In embodiments, the user image 640 is displayed in a split screen display. The CTV or OTT device can include a button that will send a video chat request 650 to the host website 620 and will be received by a human host 660. The chat request 650 statement or query by the user 640 can be a text chat, voice audio, or video chat request. The chat can be part of a website 620 or social media host site and can be used for sales, support, education, etc. The human host 660 can read the text, hear the audio, or view the video chat request 650 as it is captured and relayed to an AI machine learning model. Audio chat requests can be converted to text to allow for further analysis by an AI machine learning model and to be seen and read by the human host.

The example 600 can include user information such as demographic, economic, and geographic data. In embodiments, the user information can be included with the request for a video chat 650. The user information can include an image of the user collected 640 from the website hosting the chat, a social media platform, or the video chat request. In some instances, the image of the user 640 can be associated with a text chat username. The user information can be collected as part of the user sign-on process allowing access to the website providing the chat service, or supplied by a third-party site associated with the same username, such as an email address.

The example 600 includes capturing a video performance by the human host 660 that is in response to a chat request 650 by the user 640. The human host 660 can interact with the user 640 in real time and provide additional information regarding products for sale, support options, research materials, websites with further information, etc. The audio and video performance by the human host 660 can be captured and used as input to an AI machine learning model. The AI model can separate the human host from the background and can isolate various elements of the human host performance, including facial features, gestures, articles of clothing, accessories, vocal inflections, tone, cadence, the text of the words spoken by the host, etc.

The example 600 includes retrieving an image for a synthetic host 670, wherein the image includes a representation of an individual. In some embodiments, the retrieving of image can include a video of the individual. The retrieving can further comprise retrieving an image of the individual based on information about the user. An image of the user can be combined with the demographic, economic, and geographic information collected from the website hosting the chat and can be used as input to an artificial intelligence (AI) machine learning model. In embodiments, an AI machine learning model can be trained to recognize ethnicity, sex, and age. The AI machine learning model can access a library of images of individuals that can be used as synthetic hosts. The library of images can include options of ethnicity, sex, age, hair color and style, clothing, accessories, etc. Information related to each host image can be stored as metadata with each image.

The example 600 includes extracting, using one or more processors, aspects of the individual from the image that was retrieved. In embodiments, the aspects of the individual can include clothing, accessories, facial expressions, gestures, and so on. The aspects of the individual can be isolated and altered, swapped, or deleted as needed in order to change the appearance of the image to be used as a synthetic host. The changes can be used to create the best match of the synthetic host to the user that submitted the chat request. In some embodiments, a product for sale that is highlighted as part of the website hosting the chat or highlighted by the host during the chat can be included in the changing of the appearance of the synthetic host. The extracting of aspects of the individual is accomplished using machine learning. Machine learning artificial intelligence (AI) algorithms can be used to separate an individual in the foreground of an image from the remainder of the image, and to separate specific elements of the image from the individual. The extracted image or images of the individual can be used to generate a 3D model of the individual's head, face, and in some implementations, upper body.

The example 600 includes creating a synthetic host performance 680, wherein the video performance of the human host 660 is replaced by the individual that was extracted, and wherein the synthetic host performance 680 is created dynamically and wherein the synthetic host performance 680 responds to the statement or query by the user 640. In embodiments, creating a synthetic host performance 680 can include changing a background of the synthetic host, wherein the background comprises images, text, audio, or video. Synthesized host performances are created using a generative model. Generative models are a class of statistical models that can generate new data instances. The generative model can include a generative adversarial network (GAN). A generative adversarial network (GAN) includes two parts. A generator learns to generate plausible data. The generated instances are input to a discriminator. The discriminator learns to distinguish the generator's fake data from real data. The discriminator penalizes the generator for generating implausible results. During the training process, over time, the output of the generator improves, and the discriminator has less success distinguishing real output from fake output. The generator and discriminator can be implemented as neural networks, with the output of the generator connected to the input of the discriminator. The discriminator may use training data coming from two sources, real data, which can include images of real objects and fake data, which are images created by the generator based on the image selected to be used as the synthetic host 670. In embodiments, multiple images of a synthetic host may be used to create a synthesized chat video that replaces the human host performance in the chat with a performance by the synthesized host. In some embodiments, creating a synthetic host performance can include changing the background of the synthetic host. Changing the background can include images, text, audio, or video added to the performance in order to highlight products for sale, underscore important concepts, demonstrate product uses, etc.

The example 600 includes rendering the video chat, wherein the video chat includes the synthetic host performance 680. In embodiments, the video chat includes the user and the synthetic host. The user and the synthetic host can be displayed in a split screen display. The user can see and hear the synthetic host performing 680 the response captured from the human host 660 to the user's comment or question. In some embodiments, an image of the synthetic host is displayed to the user. Text chats can include an image or avatar of the chat participant. The user can see their own image associated with his or her text messages and an image of the synthetic host associated with the text responses from the human host.

The example 600 includes supplementing the video chat with one or more additional synthetic host performances. The one or more additional host performances can be based on at least one further statement or query by the user. In embodiments, the user can continue to make comments, ask questions, and participate in the video chat after the first synthetic host performance has been rendered. The human host 660 can see the chat comments made by the user and can respond to them. As the human host responds, an AI machine learning model can generate additional synthetic host performances, using the image selected after the initial chat request was received. In this way, the user continues to be engaged by the synthetic host and is encouraged to participate in additional sales opportunities, continuing education classes, etc.

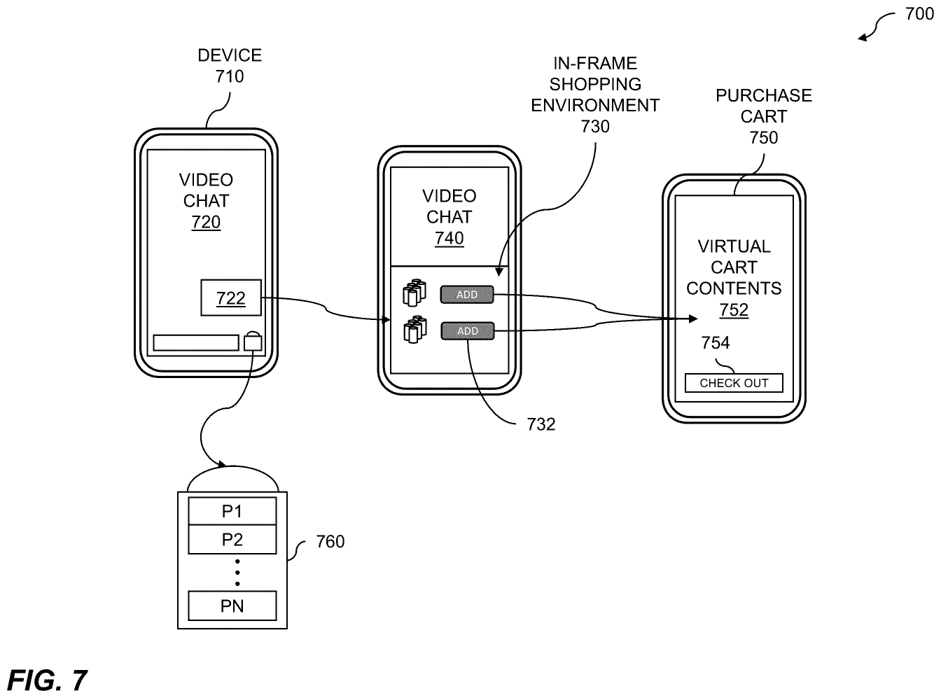

FIG. 7 illustrates an ecommerce purchase. As described above and throughout, a video chat including a synthetic host performance can be rendered to a user in response to a statement or query. The video chat can include multiple synthesized video segments that can be inserted into the video chat in response to comments from viewers. The video chat and the website or social network platform hosting the video chat can highlight one or more products available for purchase during the chat. An ecommerce purchase can be enabled during the video chat using an in-frame shopping environment. The in-frame shopping environment can allow participants of the video chat to buy products and services during the video chat. The video chat can include an on-screen product card that can be viewed on a CTV or mobile device. The in- frame shopping environment or window can also include a virtual purchase cart that can be used by viewers as the video chat plays.

The illustration 700 includes a device 710 displaying a video chat 720. In embodiments, the device 710 can be a smart TV which can be directly attached to the Internet; a television connected to the Internet via a cable box, TV stick, or game console; an Over-the-Top (OTT) device such as a mobile phone, laptop computer, tablet, pad, or desktop computer; etc. In some embodiments, the accessing the video chat on the device can be accomplished using a browser or another application running on the device.

The illustration 700 includes generating and revealing a product card 722 on the device 710. In embodiments, the product card represents at least one product available for purchase while the video chat plays. Embodiments can include inserting a representation of the first object into the on-screen product card. A product card is a graphical element such as an icon, thumbnail picture, thumbnail video, symbol, or other suitable element that is displayed in front of the video. The product card is selectable via a user interface action such as a press, swipe, gesture, mouse click, verbal utterance, or other suitable user action. The product card can be inserted while the video chat including a synthetic host performance is visible on the device. When the product card is invoked, an in-frame shopping environment 730 is rendered over a portion of the video chat while the video chat continues to play. This rendering enables an ecommerce purchase 732 by a user while preserving a continuous video chat session. In other words, the user is not redirected to another site or portal that causes the video chat to stop. Thus, viewers can initiate and complete a purchase completely inside of the video chat user interface, without being directed away from the video chat. Allowing the video chat to play during the purchase can enable improved audience engagement, which can lead to additional sales and revenue, one of the key benefits of disclosed embodiments. In some embodiments, the additional on-screen display that is rendered upon selection or invocation of a product card conforms to an Interactive Advertising Bureau (IAB) format. A variety of sizes are included in IAB formats, such as for a smartphone banner, mobile phone interstitial, and the like.

The illustration 700 includes rendering an in-frame shopping environment 730 enabling a purchase of the at least one product for sale by the viewer, wherein the ecommerce purchase is accomplished within the video chat window 740. In embodiments, the video chat can include a synthetic host performance in a split screen window with the user. The enabling can include revealing a virtual purchase cart 750 that supports checkout 754 of virtual cart contents 752, including specifying various payment methods and application of coupons and/or promotional codes. In some embodiments, the payment methods can include fiat currencies such as United States dollar (USD), as well as virtual currencies, including cryptocurrencies such as Bitcoin. In some embodiments, more than one object (product) can be highlighted and enabled for ecommerce purchase. In embodiments, when multiple items 760 are purchased via product cards during the video chat, the purchases are cached until termination of the video, at which point the orders are processed as a batch. The termination of the video chat can include the user stopping the chat, the user exiting the video window, or the video chat ending. The batch order process can enable a more efficient use of computer resources, such as network bandwidth, by processing the orders together as a batch instead of processing each order individually.

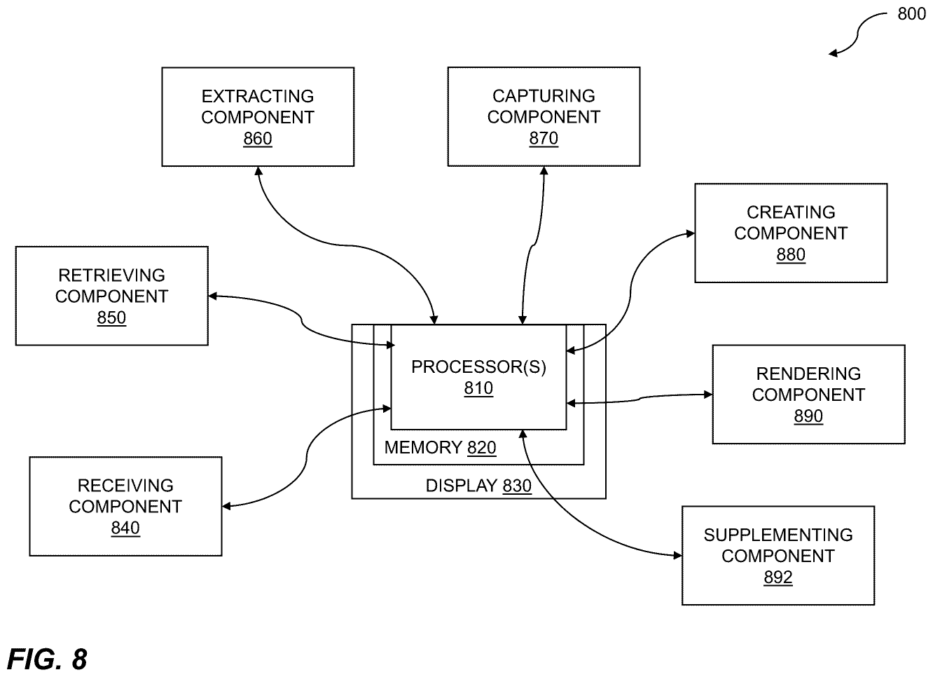

FIG. 8 is a system diagram 800 for dynamic synthetic video chat agent replacement. The system 800 can include one or more processors 810 coupled to a memory 820 which stores instructions. The system 800 can include a display 830 coupled to the one or more processors 810 for displaying data, video streams, videos, intermediate steps, instructions, and so on. In embodiments, one or more processors 810 are coupled to the memory 820 where the one or more processors, when executing the instructions which are stored, are configured to: receive, by a human host, a request for a video chat, wherein the request is initiated by a user; retrieve an image for a synthetic host, wherein the image includes a representation of an individual; extract, using one or more processors, aspects of the individual from the image that was retrieved; capture a video performance by the human host that is in response to a statement or query by the user; create a synthetic host performance, wherein the video performance of the human host is replaced by the individual that was extracted, and wherein the synthetic host performance is created dynamically, and wherein the synthetic host performance responds to the statement or query by the user; render the video chat, wherein the video chat includes the synthetic host performance; and supplement the video chat with one or more additional synthetic host performances.

The system 800 can include a receiving component 840. The receiving component 840 can include functions and instructions for providing video analysis for receiving, by a human host, a request for a video chat, wherein the request is initiated by a user. In embodiments, the request for a video chat can comprise text, voice audio, or video. In some embodiments, the request for a video chat can include information about the user. The user information can include demographic, economic, and geographic data. The user information can be collected as part of the user sign-on process allowing access to the website providing the chat service, or can be supplied by a third-party site associated with the same username, such as an email address. The user information can include an image of the user. The image of the user can be received from a website or social media platform hosting a video chat or captured from a user request for a video chat. In some embodiments, the receiving can include at least one further statement or query by the user. The at least one further statement or query can be a response by the user to a synthetic host performance.

The system 800 can include a retrieving component 850. The retrieving component 850 can include functions and instructions for retrieving an image for a synthetic host, wherein the image includes a representation of an individual. The retrieving an image further comprises selecting an image of the individual based on the information about the user. The user information can include demographic, economic, and geographic data. The user information can include an image of the user. The image of the user can be received from a website or social media platform hosting a video chat or captured from a user request for a video chat. In some embodiments, the retrieving an image for a synthetic host includes a video of the individual. The image of the user can be combined with the demographic, economic, and geographic information collected from the website hosting the chat and can be used as input to an artificial intelligence (AI) machine learning model. In embodiments, an AI machine learning model can be trained to recognize ethnicity, sex, and age. The AI machine learning model can access a library of images of individuals that can be used as synthetic hosts. The library of images can include options of ethnicity, sex, age, hair color and style, clothing, accessories, etc. Information related to each host image can be stored as metadata with each image.

The system 800 can include an extracting component 860. The extracting component 860 can include functions and instructions for extracting, using one or more processors, aspects of the individual from the image that was retrieved. In embodiments, the aspects of the individual can include one or more gestures, articles of clothing, accessories, facial expressions, gender, age, nationality, and so on. The extracting is accomplished using machine learning. The aspects of the individual can be isolated and altered, swapped, or deleted as needed in order to customize the appearance of the image to be used as a synthetic host. The customizations can be used to create the best match of the synthetic host to the user that submitted the chat request. In some embodiments, a product for sale that is highlighted as part of the website hosting the chat or highlighted by the host during the chat can be included in the customizing of the appearance of the synthetic host.

The system 800 can include a capturing component 870. The capturing component 870 can include functions and instructions for capturing a video performance by the human host that is in response to a statement or query by the user. The human host can interact with the user in real time and can provide additional information regarding products for sale, support options, research materials, websites with further information, etc. The video performance by the human host can be used as input to an AI machine learning model. The AI model can separate the human host from the background and can isolate various elements of the human host performance, including facial features, gestures, articles of clothing, accessories, vocal inflections, tone, cadence, the text of the words spoken by the host, etc.

The system 800 can include a creating component 880. The creating component 880 can include functions and instructions for creating a synthetic host performance, wherein the video performance of the human host is replaced by the individual that was extracted, and wherein the synthetic host performance is created dynamically, and wherein the synthetic host performance responds to the statement or query by the user. In embodiments, the creating a synthetic host performance further comprises changing attributes of the synthetic host. The attributes can include one or more gestures, articles of clothing, accessories, facial features, facial expressions, background images, and so on. The creating a synthetic host performance further comprises changing a background of the synthetic host. The background can comprise images, text, audio, or video. Synthetic host performance videos are created using a generative model. Generative models are a class of statistical models that can generate new data instances. The generative model can include a generative adversarial network (GAN). A generative adversarial network (GAN) includes two parts. A generator learns to generate plausible data. The generated instances are input to a discriminator. The discriminator learns to distinguish the generator's fake data from real data. The discriminator penalizes the generator for generating implausible results. During the training process, over time, the output of the generator improves, and the discriminator has less success distinguishing real output from fake output. The generator and discriminator can be implemented as neural networks, with the output of the generator connected to the input of the discriminator. Embodiments may utilize backpropagation to create a signal that the generator neural network uses to update its weights.

The discriminator may use training data coming from two sources, real data, which can include images of real objects (the human host of the chat, products for sale, etc.), and fake data, which are images created by the generator based on the image selected to be used as the synthetic host. The discriminator uses the fake data as negative examples during the training process. A discriminator loss function is used to update weights via backpropagation for discriminator loss when it misclassifies an image. The generator learns to create fake data by incorporating feedback from the discriminator. Essentially, the generator learns how to “trick” the discriminator into classifying its output as real. A generator loss function is used to penalize the generator for failing to trick the discriminator. Thus, in embodiments, the generative adversarial network (GAN) includes two separately trained networks. The discriminator neural network can be trained first, followed by training the generative neural network, until a desired level of convergence is achieved. In embodiments, multiple images of a synthetic host may be used to create a synthesized chat video that replaces the human host performance in the chat with a performance by the synthesized host. In embodiments, the creating a synthetic host performance further comprises customizing an appearance of the synthetic host, wherein the customizing is based on the information from the user. The customizing can include a vocal accent, intonation, rhythm, or pitch of a voice of the synthetic host; the clothing or accessories of the synthetic host; the gender, age, or nationality of the synthetic host; and so on. The creating a synthetic host performance further comprises creating an image of a synthetic host, wherein the creating is based on the individual from the image.

The system 800 can include a rendering component 890. The rendering component 890 can include functions and instructions for rendering the video chat, wherein the video chat includes the synthetic host performance. In embodiments, the video chat includes the user and the synthetic host, wherein the user and the synthetic host are displayed in a split screen display. In some embodiments, the rendering further comprises displaying, to the user, the image of the synthetic host. The user can see and hear the synthetic host performing the response captured from the human host to the user's comment or question. In some embodiments, an image of the synthetic host is displayed to the user. Text chats can include an image or avatar of the chat participant. The user can see an image of the user associated with his or her text messages and an image of the synthetic host associated with the text responses from the human host.

The video chat can support an ecommerce purchase. A device used to participate in a video chat can be an Over-the-Top (OTT) device such as a mobile phone, laptop computer, tablet, pad, or desktop computer; etc. The accessing the video chat can be accomplished using a browser or another application running on the device. A product card can be generated and rendered on the device viewing the video chat. In embodiments, the product card represents at least one product available for purchase on the website hosting the chat or highlighted during the video chat. Embodiments can include inserting a representation of a product for sale into the on-screen product card. A product card is a graphical element such as an icon, thumbnail picture, thumbnail video, symbol, or other suitable element that is displayed in front of the video. The product card is selectable via a user interface action such as a press, swipe, gesture, mouse click, verbal utterance, or other suitable user action. When the product card is invoked, an in-frame shopping environment can be rendered over a portion of the video chat while the chat continues to play. This rendering enables an ecommerce purchase by a user while preserving a continuous video chat session. In other words, the user is not redirected to another site or portal that causes the video chat to stop. Thus, viewers are able to initiate and complete a purchase completely inside of the video chat user interface, without being directed away from the currently playing chat. Allowing the video chat to play during the purchase can enable improved audience engagement, which can lead to additional sales and revenue, one of the key benefits of disclosed embodiments. In some embodiments, the additional on-screen display that is rendered upon selection or invocation of a product card conforms to an Interactive Advertising Bureau (IAB) format. A variety of sizes are included in IAB formats, such as for a smartphone banner, mobile phone interstitial, and the like.

The system 800 can include a supplementing component 892. The supplementing component 892 can include functions and instructions for supplementing the video chat with one or more additional synthetic host performances. In embodiments, the one or more additional host performances are based on at least one further statement or query by the user. The statement or query by the user can comprise text, voice audio, or video. The user can continue to make comments, ask questions, and participate in the video chat after the first synthetic host performance has been rendered. The human host can see the chat comments made by the user and can respond to them. As the human host responds, an AI machine learning model can generate additional synthetic host performances, using the image selected and customized after the initial chat request was received. In this way, the user continues to be engaged by the synthetic host and is encouraged to participate in additional sales opportunities, continuing education classes, etc.

The system 800 can include a computer program product embodied in a non- transitory computer readable medium for video analysis, the computer program product comprising code which causes one or more processors to perform operations of: receiving, by a human host, a request for a video chat, wherein the request is initiated by a user; retrieving an image for a synthetic host, wherein the image includes a representation of an individual; extracting, using one or more processors, aspects of the individual from the image that was retrieved; capturing a video performance by the human host that is in response to a statement or query by the user; creating a synthetic host performance, wherein the video performance of the human host is replaced by the individual that was extracted, and wherein the synthetic host performance is created dynamically, and wherein the synthetic host performance responds to the statement or query by the user; rendering the video chat, wherein the video chat includes the synthetic host performance; and supplementing the video chat with one or more additional synthetic host performances.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams, infographics, and flowchart illustrations depict methods, apparatus, systems, and computer program products. The elements and combinations of elements in the block diagrams, infographics, and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for video analysis comprising:
receiving, by a human host, a request for a video chat, wherein the request is initiated by a user;
retrieving an image for a synthetic host, wherein the image includes a representation of an individual;
extracting, using one or more processors, aspects of the individual from the image that was retrieved;
capturing a video performance by the human host that is in response to a statement or query by the user;
creating a synthetic host performance, wherein the video performance of the human host is replaced by the individual that was extracted, and wherein the synthetic host performance is created dynamically, and wherein the synthetic host performance responds to the statement or query by the user;
rendering the video chat, wherein the video chat includes the synthetic host performance; and
supplementing the video chat with one or more additional synthetic host performances.

2. The method of claim 1 wherein the one or more additional synthetic host performances is based on at least one further statement or query by the user.

3. The method of claim 1 wherein the creating a synthetic host performance further comprises changing attributes of the synthetic host.

4. The method of claim 1 wherein the creating a synthetic host performance further comprises changing a background of the synthetic host.

5. The method of claim 4 wherein the background comprises images, text, audio, or video.

6. The method of claim 1 wherein the request for a video chat includes information about the user.

7. The method of claim 6 wherein the retrieving an image further comprises selecting an image of the individual based on the information about the user.

8. The method of claim 6 further comprising customizing an appearance of the synthetic host, wherein the customizing is based on the information from the user.

9. The method of claim 8 wherein the customizing includes an accent of the synthetic host.

10. The method of claim 8 wherein the customizing includes a gender of the synthetic host.

11. The method of claim 8 wherein the customizing includes an intonation or pitch of a voice of the synthetic host.

12. The method of claim 8 wherein the customizing includes clothing or accessories of the synthetic host.

13. The method of claim 8 wherein the customizing includes a nationality of the synthetic host.

14. The method of claim 8 wherein the customizing includes an age of the synthetic host.

15. The method of claim 8 further comprising highlighting, by the synthetic host, a product for sale.

16. The method of claim 1 further comprising creating an image of a synthetic host, wherein the creating is based on the individual from the image.

17. The method of claim 16 further comprising displaying, to the user, the image of the synthetic host.

18. The method of claim 1 wherein the video chat includes the user and the synthetic host.

19. The method of claim 18 wherein the user and the synthetic host are displayed in a split screen display.

20. The method of claim 1 wherein the retrieving an image for a synthetic host includes a video of the individual.

21. The method of claim 1 wherein the video chat supports an ecommerce purchase.

22. A computer program product embodied in a non-transitory computer readable medium for video analysis, the computer program product comprising code which causes one or more processors to perform operations of:
receiving, by a human host, a request for a video chat, wherein the request is initiated by a user;
retrieving an image for a synthetic host, wherein the image includes a representation of an individual;
extracting aspects of the individual from the image that was retrieved;
capturing a video performance by the human host that is in response to a statement or query by the user;
creating a synthetic host performance, wherein the video performance of the human host is replaced by the individual that was extracted, and wherein the synthetic host performance is created dynamically, and wherein the synthetic host performance responds to the statement or query by the user;
rendering the video chat, wherein the video chat includes the synthetic host performance; and
supplementing the video chat with one or more additional synthetic host performances.

23. A computer system for video analysis, comprising:
a memory which stores instructions;
one or more processors coupled to the memory wherein the one or more processors, when executing the instructions which are stored, are configured to:
receive, by a human host, a request for a video chat, wherein the request is initiated by a user;
retrieve an image for a synthetic host, wherein the image includes a representation of an individual;
extract aspects of the individual from the image that was retrieved;
capture a video performance by the human host that is in response to a statement or query by the user;
create a synthetic host performance, wherein the video performance of the human host is replaced by the individual that was extracted, and wherein the synthetic host performance is created dynamically, and wherein the synthetic host performance responds to the statement or query by the user;
render the video chat, wherein the video chat includes the synthetic host performance; and
supplement the video chat with one or more additional synthetic host performances.
